(19) United States
(12) Patent Application Publication
(10) Pub. No.: US 2023/0189716 A1
(43) Pub. Date: Jun. 22, 2023

(54) GARDEN SHEARS

(71) Applicant: JIIN HAUR INDUSTRIAL CO.,LTD., Lu Kang Town (TW)

(72) Inventor: Shih-Piao Wu, Lu Kang Town (TW)

(21) Appl. No.: 17/555,345

(22) Filed: Dec. 17, 2021

(51) Int. Cl. A01G 3/02

(52) U.S. Cl. CPC A01G 3/021

(57) ABSTRACT

A garden shears has: a cutting blade portion and a handle portion. The cutting blade portion has a pair of cutting blades, a plurality of screws, and the handle portion has a first handle and a second handle. Each of handle portions has a metal main body and a covering layer having a polymer material. The covering layer of the second handle further has an anti-slip layer having a polymer material on an outer side surface. Each of the cutting blades has at least three screws respectively engaged with an assembling portion of the first handle and an assembling portion of the second handle. A rotatable blocking portion is installed between the first handle and the cutting blades, and the blocking portion has a stopping block and a screw engaging with the assembling portion of the first handle.

### BACKGROUND of INVENTION

### Field of Invention

The present invention relates to a garden shears.

### Description of the Related Art

Typically, gardening work, such as trimming plant leaves or cutting thick plant stems, employs normal scissors used in daily life are obviously insufficient and difficult to use, so gardening branch shears are indispensable in gardening activities.

However, the conventional gardening shears grip has common materials issue. If the grip is made of only metal, it is not only expensive, but also heavy, and even rusty easily and low heat resistance, which makes it difficult to hold in hot weather. Polymer materials make the grip has the advantages of lightness, low cost, and corrosion resistance, but the only use of polymer materials makes the grip also has the problems such as insufficient mechanical strength, intolerance to sunlight and embrittlement.

Therefore, it is desirable to provide a garden shears to mitigate and/or obviate the aforementioned problems.

### SUMMARY OF THE INVENTION

An objective of present invention is to provide a garden shears.

In order to achieve the above mentioned objective, a garden shears has: a cutting blade portion and a handle portion. The cutting blade portion has a pair of cutting blades, a plurality of screws, and the handle portion has a first handle and a second handle. Each of handle portions has a metal main body and a covering layer having a polymer material. The covering layer of the second handle further has an anti-slip layer having a polymer material on an outer side surface. Each of the cutting blades has at least three screws respectively engaged with an assembling portion of the first handle and an assembling portion of the second handle. A rotatable blocking portion is installed between the first handle and the cutting blades, and the blocking portion has a stopping block and a screw engaging with the assembling portion of the first handle.

Other objects, advantages, and novel features of invention will become more apparent from the following detailed description when taken in conjunction with the accompanying drawings.

### BRIEF DESCRIPTION OF DRAWINGS

FIG. 1 is the three-dimensional combination drawing of a preferred embodiment according to the present invention.

FIG. 2 is a three-dimensional exploded view of the preferred embodiment according to the present invention.

FIG. 3 is a sectional view of the internal structure of the first handle of the preferred embodiment according to the present invention.

FIG. 4 is a sectional view of the internal structure of the second handle of the preferred embodiment according to the present invention.

FIG. 5 is the three-dimensional internal structure drawing of the second handle of the preferred embodiment according to the present invention.

FIG. 6 is the assembled schematic drawing of the preferred embodiment according to the present invention.

FIG. 7 is the A-A cross-sectional view of FIG. 6 of the preferred embodiment according to the present invention.

### DETAILED DESCRIPTION OF THE PREFERRED EMBODIMENT

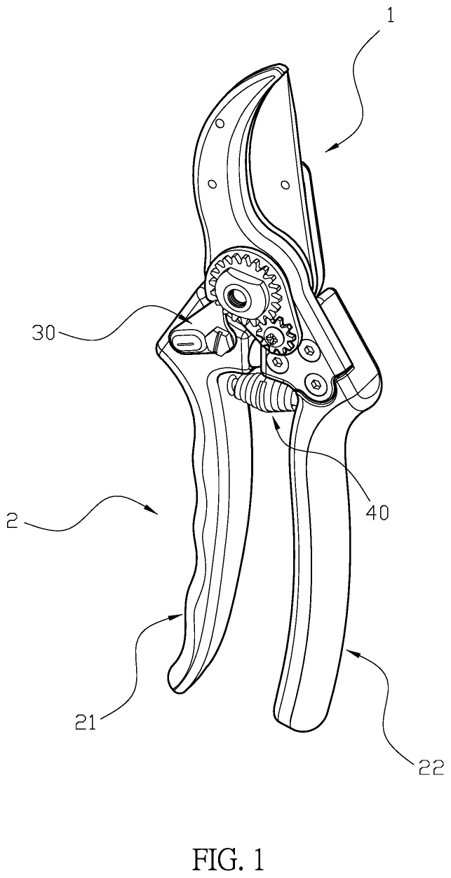

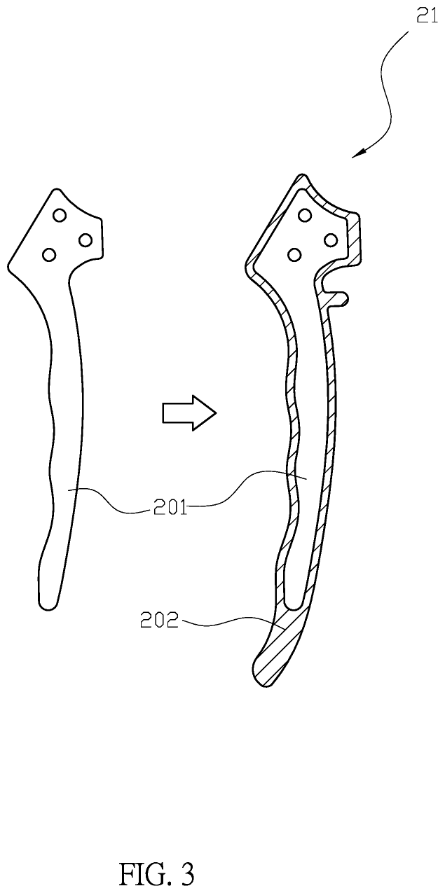

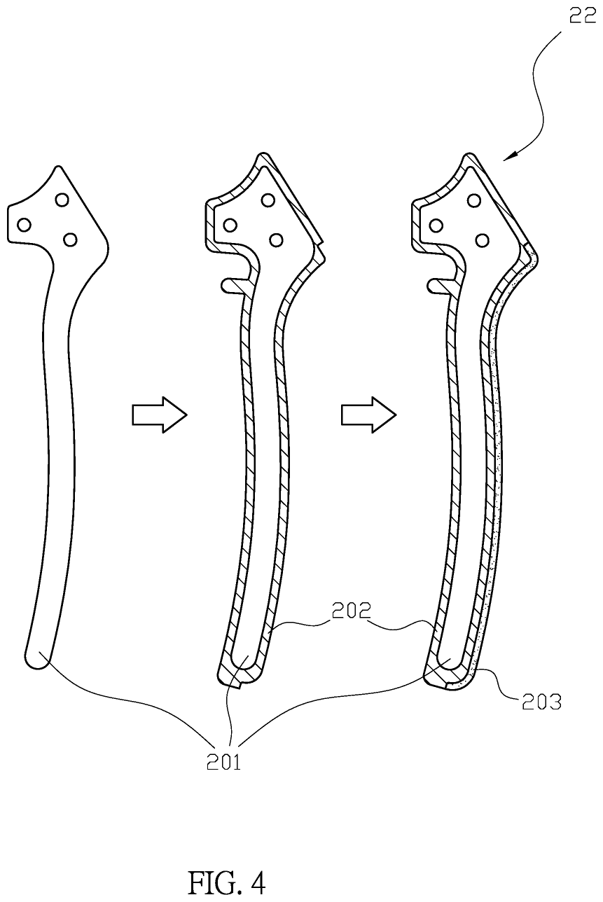

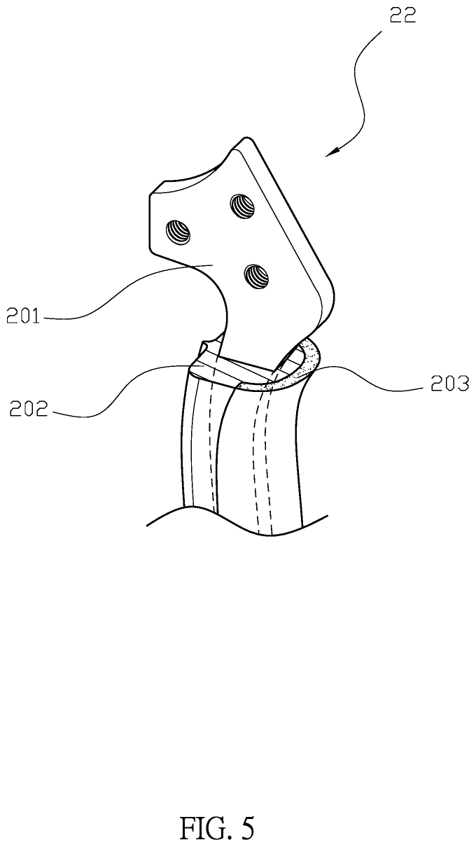

Please refer to FIG. 1-5. A garden shears comprises: a cutting blade portion 1 and a handle portion 2. The cutting blade portion 1 has a pair of cutting blades 10, a plurality of screws 11, and the handle portion 2 has a first handle 21 and a second handle 22. The handle portion 2 each of handle portions comprising a metal main body 201 and a covering layer 202 comprising a polymer material main body 201. Also, the covering layer 202 of the second handle 22 further comprising an anti-slip layer 203 comprising a polymer material on an outer side surface.

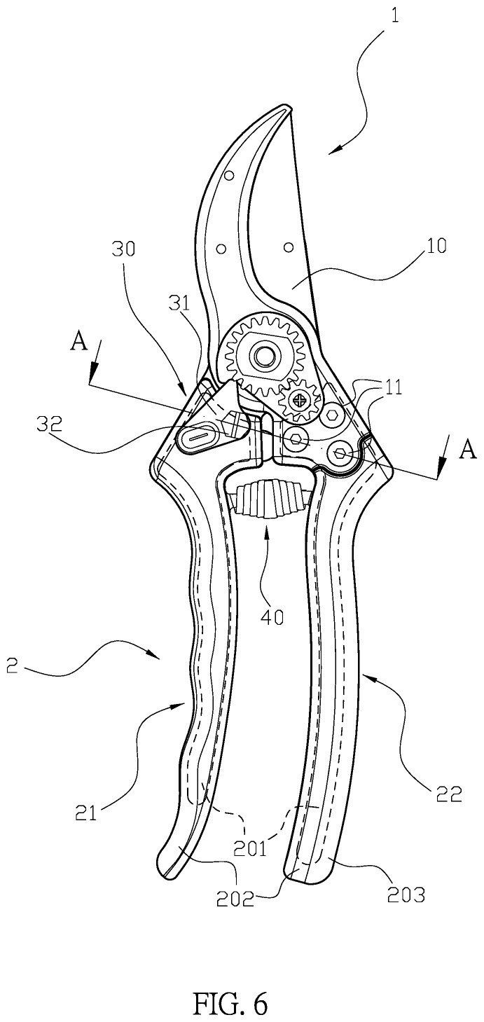

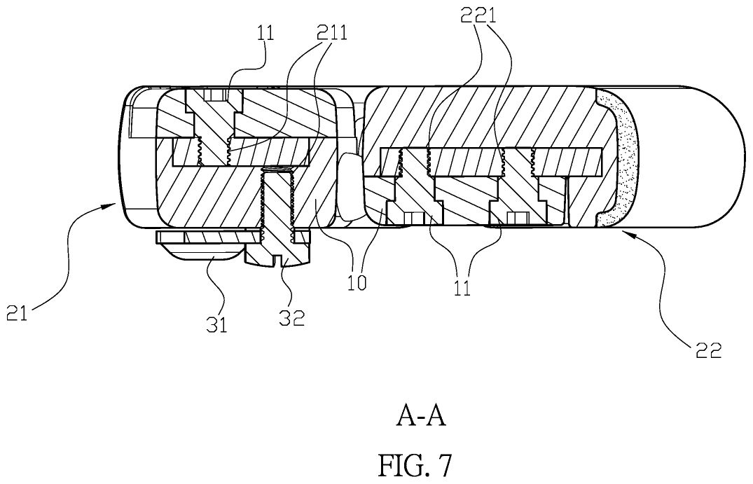

As shown in FIG. 6 and FIG. 7, each of the cutting blades 10 has three screws 11 respectively engaged with an assembling portion 211 of the first handle 21 and an assembling portion 221 of the second handle 22. A rotatable blocking portion 30 is installed between the first handle 21 and the cutting blades 10, and the blocking portion 30 has a stopping block 31 and a screw 32. The stopping block 31 is assembled with the screw 32 and the assembling portion of the first handle 21 together, and the cutting blades 10 can be locked by the blocking portion 30 of the blocking portion 30 while in the closed state to achieve the non-use safety.

With the above structure, the main body 201 of the handle portion 2 makes the handle portion 2 have good metal mechanical strength, and the covering layer 202 and the anti-slip layer 203 of the handle portion 2 make the handle portion 2 having lightness and corrosion resistance characteristics of polymer material. Furthermore, the main body 201 is covered by the covering layer 202, which has the effect of isolating air and preventing rust. Moreover, the anti-slip layer 203 provides grip improvement.

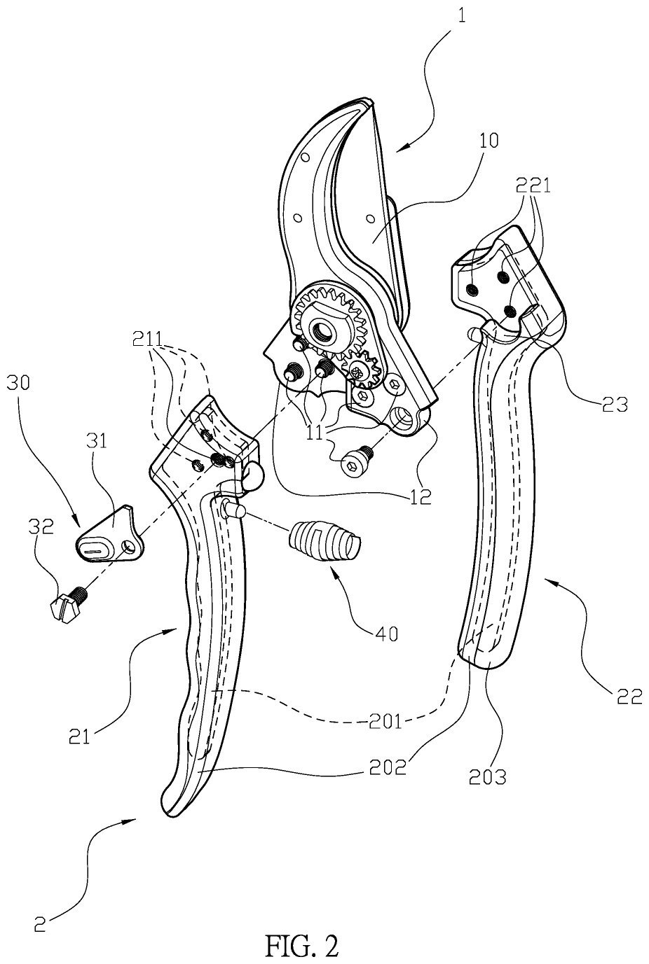

Please refer to FIG. 2 again. The cutting blade portion 1 has a raised portion 12, the handle portion 2 has a corresponding indented portion 23, and the raised portion 12 and the indented portion 23 are respective semicircles that cooperate with each other.

Each of the cutting blades 10 has at least three screws 11, such that the combination of the cutting blades 10 and the assembling portion 211 of the first handle 21 has a rigid structure to enhance the structural strength.

Each of the cutting blades 10 has at least three screws 11, such that the combination of the cutting blades 10 and the assembling portion 221 of the second handle 22 has a rigid structure to enhance the structural strength.

Moreover, the covering layer 202 is applied by a plastic injection technology used to cover the grip body 201.

The anti-slip layer 203 is applied by a plastic coating technology to cover the covering layer 202.

In addition, an elastic member 40 is installed between the first handle and 21 the second handle 22.

Furthermore, the elastic member 40 is a compression spring made by winding metal wire.

Alternatively, the elastic member 40 is a barrel spring made of metal plate.

Also, the main body 201 is made of steel.

Furthermore, the covering layer 202 is made of plastic.

Additionally, the covering layer 202 layer is made of rubber.

Also, the anti-slip layer 203 layer is made of rubber.

Alternatively, the anti-slip layer 203 is made of plastic.

Alternatively, the cutting blade portion 1 has six screws 11.

With the structure of the above specific embodiment, the following benefits can be obtained: 1. The main body 201 of the handle portion 2 is made of metal material, which can provide the handle portion 2 with good mechanical strength of the metal, thereby maintaining a rigid structure. 2. The covering layer 202 and the anti-slip layer 203 of the handle portion 2 are made of a polymer material, which can provide the handle portion 2 with anti-slip, lightness, and corrosion resistance characteristics, so that it is comfortable to use. 3. The handle portion 2 uses two different materials to obtain the material properties of both, which also reduces manufacturing costs.

Although the present invention has been explained in relation to its preferred embodiment, it is to be understood that many other possible modifications and variations can be made without departing from the spirit and scope of invention as hereinafter claimed.

What is claimed is:

1. A garden shears comprising: a cutting blade portion and a handle portion, wherein:
the cutting blade portion has a pair of cutting blades, a plurality of screws, the handle portion has a first handle and a second handle, each of handle portions comprising a metal main body and a covering layer comprising a polymer material, the covering layer of the second handle further comprising an anti-slip layer comprising a polymer material on an outer side surface; each of the cutting blades has at least three screws respectively engaged with an assembling portion of the first handle and an assembling portion of the second handle; a rotatable blocking portion is installed between the first handle and the cutting blades, and the blocking portion has a stopping block and a screw engaging with the assembling portion of the first handle.

2. The garden shears as claimed in claim 1, wherein the cutting blade portion has a raised portion, the handle portion has a corresponding indented portion, and the raised portion and the indented portion are respective semicircles that cooperate with each other.

3. The garden shears as claimed in claim 1, wherein each of the cutting blades has three screws.

4. The garden shears as claimed in claim 1, wherein the covering layer is applied by a plastic injection technology used to cover the grip body.

5. The garden shears as claimed in claim 1, wherein the anti-slip layer is applied by a plastic coating technology to cover the covering layer.

6. The garden shears as claimed in claim 1, wherein an elastic member is installed between the first handle and the second handle.

7. The garden shears as claimed in claim 1, wherein the main body is made of steel.

8. The garden shears as claimed in claim 1, wherein the covering layer is made of plastic.

9. The garden shears as claimed in claim 1, wherein the covering layer is made of rubber.

10. The garden shears as claimed in claim 1, wherein the anti-slip layer is made of rubber.

11. The garden shears as claimed in claim 1, wherein the anti-slip layer is made of plastic.

12. The garden shears as claimed in claim 1, wherein the cutting blade portion has six screws.
